(19) United States
(12) Patent Application Publication
(10) Pub. No.: US 2026/0230101 A1
(43) Pub. Date: Aug. 6, 2026

(54) MOBILE TRANSMITTER/RECEIVER UNIT

(71) Applicant: Sennheiser electronic SE & Co. KG, Wedemark (DE)

(72) Inventors: Minh Tuan Nguyen, Laatzen (DE); Timo Erdtmann, Springe (DE)

(73) Assignee: Sennheiser electronic SE & Co. KG, Wedemark (DE)

(21) Appl. No.: 19/465,379

(22) Filed: Jan. 30, 2026

(30) Foreign Application Priority Data
Feb. 3, 2025 (DE) 102025103765.5

(51) Int. Cl. H04B 1/3827

(52) U.S. Cl. CPC H04B 1/3827

(57) ABSTRACT

A mobile transmitter/receiver unit includes a transmitter/receiver housing and a control element which protrudes outwards from the transmitter/receiver housing. The control element is configured to operate the transmitter/receiver unit. The control element has at least one control element antenna for transmitting and/or receiving wireless signals for the transmitter/receiver unit.

### CROSS REFERENCE TO RELATED APPLICATIONS

This application claims priority under 35 U.S.C. § 119(a) to German Patent No. 102025103765.5, filed Feb. 3, 2025, the disclosure of which is incorporated herein by reference in its entirety.

### FIELD

The present disclosure is related to mobile transmitter/receiver units.

### BACKGROUND

Mobile transmitter/receiver units are used, for example, as so-called body packs or belt packs in wireless microphone systems or wireless in-ear monitoring systems. Typically, a body pack or belt pack is a small, portable transmitter/receiver. An audio signal is transmitted wirelessly to the body pack and the audio signal can then be relayed from the body pack to the user via a wired headset.

### SUMMARY

In some embodiments, a mobile transmitter/receiver unit for transmitting and/or receiving wireless audio signals comprises a transmitter/receiver housing for accommodating electronic circuits and a control element which protrudes outwards from the transmitter/receiver housing. The control element may have at least one control element antenna for transmitting and/or receiving wireless signals. In some embodiments, the control element has a cap and a cap receptacle wherein the cap at least partially surrounds the at least one control element antenna. In some embodiments, the cap may be rotatable and the at least one control element antenna may be rotationally fixed.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

In the drawings, each identical or nearly identical component that is illustrated in various figures may be represented by a like numeral. For purposes of clarity, not every component may be labeled in every drawing. In the drawings:

FIG. 1 shows a schematic diagram of a transmitter/receiver unit;

FIG. 2 shows a partial sectional view of the transmitter/receiver unit of FIG. 1;

FIG. 3 shows a schematic sectional view of a control element of the transmitter/receiver unit of FIG. 1; and

FIGS. 4A to 4I show different views of a control element antenna.

### DETAILED DESCRIPTION

Body packs are particularly advantageous at events where the mobility and flexibility of the user are important.

Body packs should be designed to be as inconspicuous as possible so that they do not attract attention at the event where the body pack is worn.

In the priority application of this application, the German Patent and Trademark Office has searched the following documents: US 2015/0 207 206 A1 and US 2021/0 051 386 A1

It is an object of the present disclosure to provide a mobile transmitter/receiver unit which is less conspicuous than in the prior art and at the same time enables improved audio transmission.

This object is solved by a mobile transmitter/receiver unit according to Claim 1.

Thus, a mobile transmitter/receiver unit, in particular a body pack or belt pack, is provided. The transmitter/receiver unit has a housing to accommodate the electronic circuitry for operation of the unit. Furthermore, the transmitter/receiver unit has at least one control element that protrudes from the housing. This control element has at least one antenna for transmitting and/or receiving wireless audio signals for the transmitter/receiver unit.

Thus, a transmitter/receiver unit is provided in which an antenna is arranged so that it is not conspicuous from outside. Instead, the antenna is inconspicuously integrated into the transmitter/receiver unit and in particular into the control element. This is advantageous because the antenna is not adversely affected by movements of the user and because the risk of destruction or damage to the antenna is reduced. Since the antenna protrudes from the housing as part of the control element, the irradiation of the antenna can be improved.

According to one aspect of the present disclosure, the housing is at least partially configured as a metallic housing. This is particularly advantageous with a view to use on a stage or at a concert since the transmitter/receiver unit can be configured to be more robust without negatively affecting the irradiation characteristics.

Optionally, the transmitter/receiver unit can have an additional antenna that protrudes from the housing.

The control element antenna can be designed for DECT or Bluetooth frequencies, for example. Alternatively, the control element antenna for PMSE applications can be designed for 3 GHz, for example. The term Programme Making and Special Events (PMSE) is used to describe equipment used to support broadcast transmissions, news gathering, theatrical productions and special events such as cultural events, concerts, sporting events, conferences and trade shows.

Optionally, the control element antenna can be used as a return channel for DECT or Bluetooth.

According to one aspect, the housing has an audio output or jack through which an audio signal can be supplied to a user via a wired headset.

According to one aspect, the control element has a cap, a cap receptacle, and the control element antenna. The cap at least partially surrounds the control element antenna.

The control element antenna is configured to be substantially cylindrical and has at least one electrical antenna cable.

According to another aspect, the electrical antenna cable has a first, second, and third conductor section, wherein the first conductor section is provided at the second end of the control element antenna and the second conductor section is provided at the first end of the control element antenna. A third conductor section electrically connects the first and second conductor sections.

According to one aspect, a body pack control element is provided with a control element housing and a control element antenna. The antenna is thus integrated into the control element housing.

With the transmitter/receiver unit described above, it is possible to integrate at least one antenna for wireless transmission into the elements used in the transmitter/receiver unit, in particular a control element. The control element is used to operate the transmitter/receiver unit.

With the control element antenna an antenna is provided which is integrated into a control element, whereby the function of the control element can be independent of the control element antenna. The control element antenna optionally uses the control element as its housing and as external protection. By integrating the control element antenna into the control element, which protrudes from the housing, the antenna is integrated into the transmitter/receiver unit inconspicuously and invisibly for the user.

The control element antenna unit is configured so that it does not adversely affect the function of the control element, namely the operation of the transmitter/receiver unit. The control element can be configured as a rotary knob (for example, for volume control), as a jog dial element or similar.

For the control element antenna, the mechanical configuration of the control element, which protrudes from the housing and surrounds the antenna, is advantageous both mechanically and in terms of antenna technology.

Optionally, the housing of the transmitter/receiver unit can have a display showing a menu. The menu on the display can be navigated and operated using the control element.

Since the control element protrudes from the housing, an integrated antenna can exhibit improved radiation characteristics.

Furthermore, the space required for the antenna can be reduced because the antenna is integrated into the control element. The improvement in the irradiation behaviour is particularly beneficial when the housing is a metal housing.

Furthermore, the control element antenna is advantageous because it does not require any changes to the design of the transmitter/receiver unit. Furthermore, a reduction in the number of elements that the customer could identify as an antenna can be achieved. Furthermore, no separate mechanical openings in the housing are necessary.

Optionally, the control element antenna can be placed between a cap of the control element and a radial cap receptacle.

Alternatively or additionally, the control element antenna can be arranged on a cylindrically shaped carrier material.

According to one aspect, the transmitter/receiver unit can have two antennae protruding from the housing. These two antennae can be used for antenna diversity.

According to one aspect, wireless transmission structures, in particular antennae, are integrated into mechanically already-existing control elements designed for device operation.

With the control element antenna a positioning of an offset antenna within an existing structure can be achieved, which is invisible to the customer. Since the control element antenna is located outside the housing (but within the control element itself), the antenna can have a greater range, thus increasing the benefits for the customer.

The control element can be a volume control, a menu operation via jog dial, silicone buttons or plastic switches.

The present disclosure relates to wireless microphone systems or wireless in-ear monitoring systems which have mobile transmitter/receiver units which are used, for example, as so-called body packs or belt packs.

Further embodiments are the subject of the dependent claims.

Advantages and example embodiments are explained in more detail hereinafter with reference to the drawings. Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

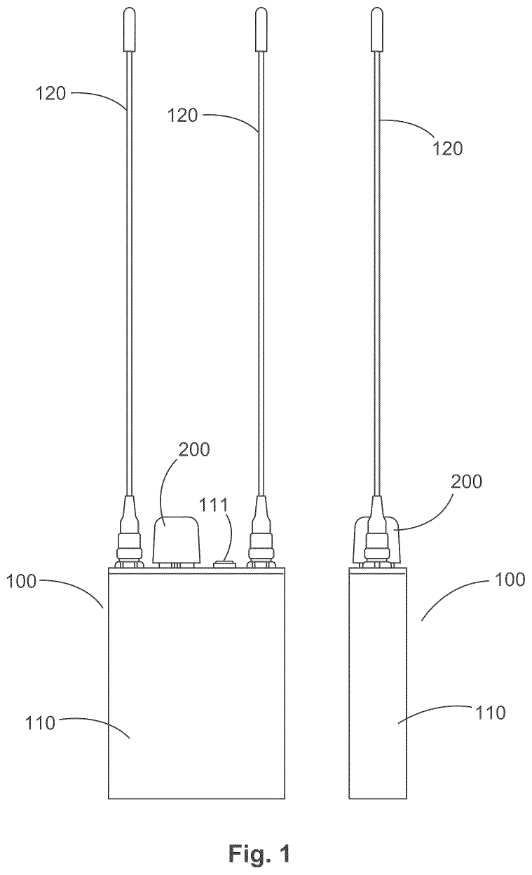

FIG. 1 shows a schematic diagram of a transmitter/receiver unit. The transmitter/receiver unit can be designed as a body pack or a belt pack. The transmitter/receiver unit 100 comprises a transmitter/receiver housing 110 and at least one antenna 120, which protrudes from the transmitter/receiver housing 110. Furthermore, the transmitter/receiver unit 100 comprises at least one control element 200, which also protrudes from the housing 110.

To improve the robustness of the transmitter/receiver unit, the transmitter/receiver housing can be made of metal or at least substantially of metal. If the housing is made of metal, then an antenna of the transmitter/receiver unit cannot easily be integrated into the housing 110.

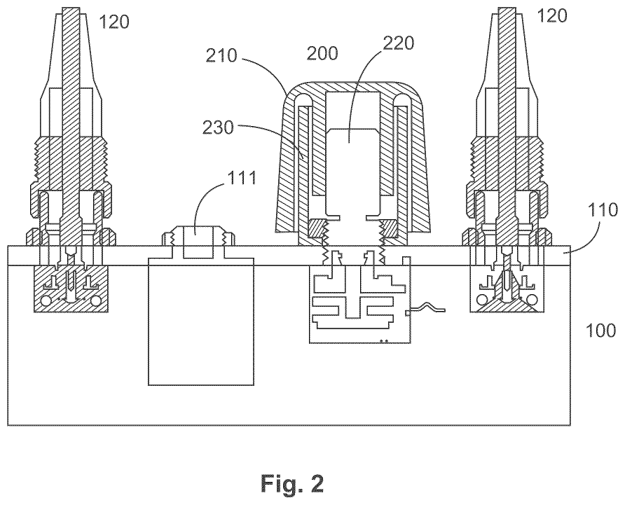

FIG. 2 shows a partial sectional view of the transmitter/receiver unit of FIG. 1. The transmitter/receiver unit comprises a transmitter/receiver housing 110, optionally with an audio output 111 and at least one antenna 120. The at least one antenna 120 protrudes beyond the housing 110.

The transmitter/receiver unit 100 further comprises a control element 200, which also protrudes from the transmitter/receiver housing 110. The control element 200 has a control knob or a cap 210, a radial cap receptacle 220, and a control element antenna 230. Thus, the control element antenna is also located outside the housing.

Actuating the cap 210 activates the cap receptacle 220.

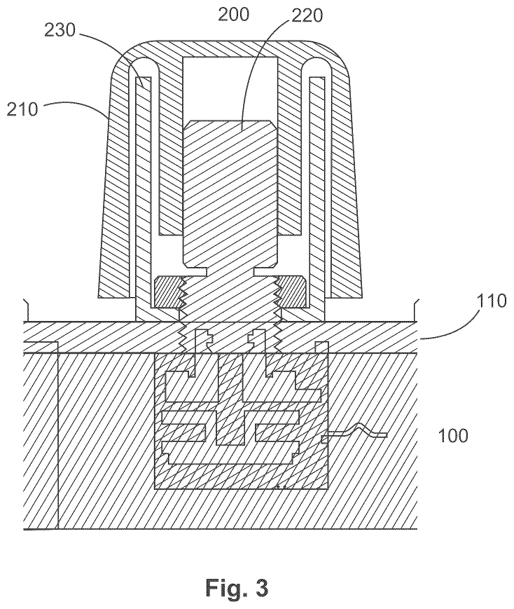

FIG. 3 shows a schematic sectional view of a control element of the transmitter/receiver unit of FIG. 1. FIG. 3 shows a section of the transmitter/receiver unit. In particular, the control element 200 is shown. The control element 200 projects beyond a housing 110 of the transmitter/receiver unit 100, so that the control element 200 is not enclosed by the housing. The control element 200 is freely accessible to the user for operating or controlling the transmitter/receiver unit 100. The control element 200 has a control element button or a control element cap 210, which interacts with a cap receptacle 220. Actuation of the cap 210 leads to actuation or movement of the cap receptacle 220, which can be detected inside the transmitter/receiver unit 100 and implemented for control. The control element 200 also has at least one control antenna 230.

The control element antenna 230 is at least partially surrounded radially by the cap 210. A movement or rotation of the cap 210 does not necessarily lead to a movement or rotation of the control element antenna unit 230. Preferably, the control element antenna 230 is configured to be rotationally fixed. The control element antenna has at least one electrical antenna cable.

The control element antenna 230 is integrated into the control element, so that a separate housing does not need to be provided for the control element antenna 230.

The control element antenna 230 is functionally independent of the rotary knob 210 or the rotary knob is independent of the control element antenna. The cap 210 and the cap receptacle 220 allow the user to control the transmitter/receiver unit 100 or intervene in the operation by actuating the cap 210. The control element 200 can, for example, be configured as a volume knob, so that the volume at an audio output 111 can thereby be adjusted.

The control element antenna 230, which serves to transmit and/or receive wireless audio signals for the transmitter/receiver unit 100, uses the control element 200 as its housing. In other words, the control element antenna 230 represents an additional antenna which is integrated into an existing element of the transmitter/receiver unit 100, without there needing to be any functional relationship between the function of the control element 200 and the function of the antenna. The control element antenna 230 integrated into the control element is advantageous because it protrudes from the transmitter/receiver housing 110 and can therefore have an improved range. This is particularly true if the transmitter/receiver housing 110 is configured as a metallic housing.

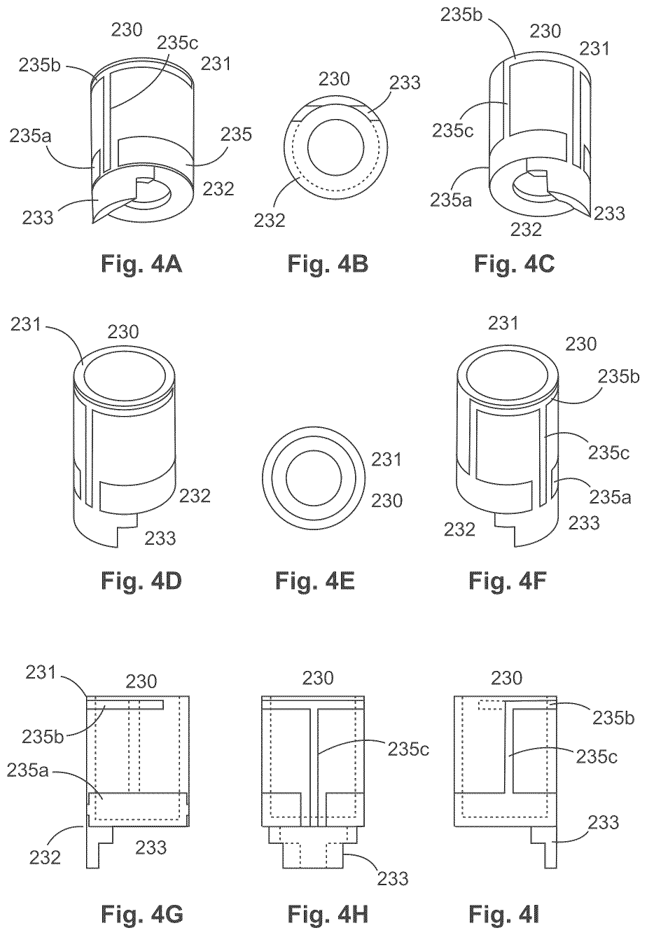

FIGS. 4A to 4I show different views of a control element antenna 230.

The control element antenna 230 has a first and second end 231, 232. A projection 233 is provided at the second end 232. The control element antenna 230 can be substantially cylindrical and can have at least one antenna cable 235.

The control element antenna 230 has an electrical antenna cable 235. The electrical antenna cable 235 has a first, second, and third cable section 235a, 235b, and 235c. The first cable section 235a can be provided in the region of the second end 232, and the second cable section 235b can be provided in the region of the first end 231. A third cable section 235c can connect the first and second sections 235a and 235b to one another.

Optionally, the first cable section 235a extends radially in the region of the second end 232, and the second electrical cable section 235b extends radially in the region of the first end 231 of the control element antenna 230. The third cable section 235c extends axially between the first and second cable sections 235a, 235b.

### REFERENCE LIST

100 Transmitter/receiver unit
110 Transmitter/receiver housing
111 Audio output
120 Antenna
200 Control element
210 Cap
220 Cap holder
230 Control element antenna
231 First end
232 Second end
233 Projection
235 Antenna cable
235a First cable section
235b Second cable section
235c Third cable section

Various aspects of the embodiments described above may be used alone, in combination, or in a variety of arrangements not specifically discussed in the embodiments described in the foregoing and are therefore not limited in their applications to the details and arrangement of components set forth in the foregoing description or illustrated in the drawings. For example, aspects described in one embodiment may be combined in any manner with aspects described in other embodiments.

The phrase “and/or,” as used herein in the specification and in the claims, should be understood to mean “either or both,” of the elements so conjoined, e.g., elements that are conjunctively present in some cases and disjunctively present in other cases. Multiple elements listed with “and/or” should be construed in the same fashion, e.g., “one or more” of the elements so conjoined. Other elements may optionally be present other than the elements specifically identified by the “and/or” clause, whether related or unrelated to those elements specifically identified. Thus, as a non-limiting example, a reference to “A and/or B,” when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

The indefinite articles “a” and “an,” as used herein in the specification and in the claims, unless clearly indicated to the contrary, should be understood to mean “at least one.”

As used herein in the specification and in the claims, the phrase, “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently, “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

All definitions, as defined and used herein, should be understood to control over dictionary definitions, definitions in documents incorporated by reference, and/or ordinary meanings of the defined terms.

Having thus described several aspects of at least one embodiment, it is to be appreciated that various alterations, modifications, and improvements will readily occur to those skilled in the art. Such alterations, modifications, and improvements are intended to be part of this disclosure and are intended to be within the scope of the principles described herein. Accordingly, the foregoing description and drawings are by way of example only.

What is claimed is:

1. A mobile transmitter/receiver unit for transmitting and/or receiving wireless audio signals, comprising:
a transmitter/receiver housing for accommodating electronic circuits; and
a control element which protrudes outwards from the transmitter/receiver housing,
wherein the control element has at least one control element antenna for transmitting and/or receiving wireless signals,
wherein the control element has a cap and a cap receptacle,
wherein the cap at least partially surrounds the at least one control element antenna,
wherein the cap is rotatable, and
wherein the at least one control element antenna is rotationally fixed.

2. A mobile transmitter/receiver unit according to claim 1, wherein the transmitter/receiver housing is a metallic housing.

3. A mobile transmitter/receiver unit according to claim 1, further comprising:
at least one antenna protruding from the transmitter/receiver housing for transmitting and/or receiving wireless signals.

4. A mobile transmitter/receiver unit according to claim 1, wherein the transmitter/receiver housing has an audio output.

5. A mobile transmitter/receiver unit according to claim 1, wherein the rotatable cap and the cap receptacle allow a user to control the mobile transmitter/receiver unit.

6. A mobile transmitter/receiver unit according to claim 5, wherein the at least one control element antenna is configured to be cylindrical and has at least one electrical antenna cable.

7. A mobile transmitter/receiver unit according to claim 6, wherein the at least one electrical antenna cable has a first cable section, a second cable section and a third cable section, wherein the first cable section and the second cable section are provided at opposite ends of the at least one control element antenna and the third cable section electrically connects the first and third cable sections.

8. A wireless audio transmission system, in particular a wireless microphone system or wireless in-ear monitoring system, comprising at least one mobile transmitter/receiver unit according to claim 1.
